(19) United States
(12) Patent Application Publication
(10) Pub. No.: US 2019/0152487 A1
(43) Pub. Date: May 23, 2019

(54) ROAD SURFACE ESTIMATION DEVICE, VEHICLE CONTROL DEVICE, AND ROAD SURFACE ESTIMATION METHOD

(71) Applicant: Panasonic Intellectual Property Management Co., Ltd., Osaka (JP)

(72) Inventors: TAKAFUMI TOKUHIRO, Kanagawa (JP); SATOSHI FUKUMOTO, Tokyo (JP); ICHIRO YAMANE, Kanagawa (JP)

(21) Appl. No.: 16/254,876

(22) Filed: Jan. 23, 2019

Related U.S. Application Data
(63) Continuation-in-part of application No. PCT/JP2017/023467, filed on Jun. 27, 2017.

(30) Foreign Application Priority Data
Aug. 12, 2016 (JP) 2016-158836

(51) Int. Cl. B60W 40/06; B60W 50/00; B60G 17/0165; G06T 7/593; G06K 9/62; G06K 9/00

(52) U.S. Cl. CPC B60W 40/06; G06T 2207/30256; B60G 17/0165; G06T 7/593; G06K 9/623; G06K 9/00798; B60W 2720/10; B60W 2720/24; B60W 2050/0052; B60W 2420/42; B60W 2050/0077; B60W 2710/22; B60W 2550/14; B60G 2400/82; B60W 2050/0028; G06T 2207/10012; G06T 2207/10028; B60W 50/00

(57) ABSTRACT

A road surface estimation device includes a spatial measurement unit, a filter, and a road surface estimator. The spatial measurement unit measures a three-dimensional measurement point cloud on a road surface on the basis of an image received from a stereo camera or a camera capable of three-dimensional measurement. The filter filters the three-dimensional measurement point cloud on the basis of a road surface model created based on map information so as to obtain road surface candidate points. The road surface estimator estimates the road surface on the basis of the road surface candidate points.

### CROSS-REFERENCE TO RELATED APPLICATIONS

This application is a continuation-in-part of the PCT International Application No. PCT/JP2017/023467 filed on Jun. 27, 2017, which claims the benefit of foreign priority of Japanese patent application No. 2016-158836 filed on Aug. 12, 2016, the contents all of which are incorporated herein by reference.

### BACKGROUND

### 1. Technical Field

The present disclosure relates to a road surface estimation device, vehicle control device, and road surface estimation method.

### 2. Description of the Related Art

Devices for estimating a road profile and so on using a computer, based on an image captured by a camera, have been developed in line with increasing computer throughput. One of road profile estimation devices proposed is configured to roughly estimate a profile of road on which a vehicle is traveling by checking a road profile estimated on the basis of an image captured by a monocular camera with a road profile in a digital road map (for example, Japanese Patent Unexamined Publication No. 2001-331787).

In a study of image processing technology related to vehicle-mounted stereo cameras, detection of a road surface is an important issue. This is because accurate road-surface detection enables further efficient search of driving route and recognition of obstacles, such as pedestrians and other vehicles.

### SUMMARY

The present disclosure offers a road surface estimation device with improved detection accuracy.

The road surface estimation device of the present disclosure includes a spatial measurement unit, a filter, and a road surface estimator. The spatial measurement unit measures a three-dimensional measurement point cloud on a road surface on the basis of an image received from a stereo camera or a camera capable of three-dimensional measurement. The filter filters the three-dimensional measurement point cloud on the basis of a road surface model created based on map information so as to obtain road surface candidate points. The road surface estimator estimates the road surface on the basis of the road surface candidate points.

A vehicle control device of the present disclosure includes the road surface estimation device of the present disclosure and a controller that controls a vehicle in which the vehicle control device is installed. The controller controls the vehicle according to a road surface estimated by the road surface estimation device.

The present disclosure offers the road surface estimation device with improved detection accuracy.

### BRIEF DESCRIPTION OF DRAWINGS

FIG. 1 is a block diagram of a road surface estimation device in accordance with a first exemplary embodiment.

FIG. 2 illustrates coordinate conversion between the x-y-z coordinate system and the u-v-disparity coordinate system.

FIG. 3 is a projection view of a road surface model and three-dimensional measurement point cloud on a y-z plane in the x-y-z coordinate system.

FIG. 4 is an operation flow chart of the road surface estimation device in accordance with the first exemplary embodiment.

FIG. 5 is an example of hardware configuration of computer 2100.

FIG. 6 is a block diagram of a road surface estimation device in accordance with a second exemplary embodiment.

### DETAILED DESCRIPTION OF PREFERRED EMBODIMENTS

Prior to describing an exemplary embodiment of the present disclosure, problems in the prior art are described briefly. In general, a road surface has differences in level (height) and dents. To identify a stereoscopic shape of a difference in level, a dent, or the like in the road surface by passive three-dimensional measurement without emission of laser beam, a plurality of parallax images taken by two or more cameras (stereo cameras) is necessary. Recently, global matching methods, such as Semi-Global Matching (SGM), have been developed to obtain road surface information as a point cloud in a three-dimensional space from images taken by stereo cameras, without using edge information, such as white lines on the road surface. However, the point cloud obtained by SGM contains errors. Due to those errors, the points in the point cloud that are supposed to be distributed on the road surface are distributed vertically with respect to the road surface. As a result, the stereoscopic shape of road surface cannot be accurately estimated on the basis of the point cloud.

The exemplary embodiment of the present disclosure is described below with reference to drawings. Same reference marks in the drawings indicate identical or equivalent parts.

### First Exemplary Embodiment

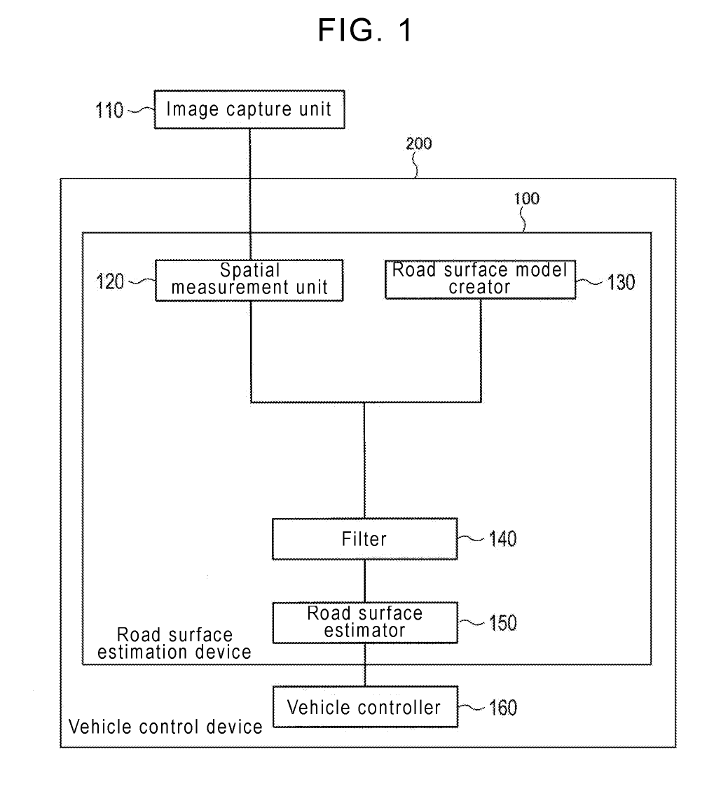

FIG. 1 is a block diagram of vehicle control device 200 in a first exemplary embodiment.

Vehicle control device 200 is connected to external image capture unit 110, and includes road surface estimation device 100 and vehicle controller 160. Alternatively, road surface estimation device 100 or vehicle controller 160 may include image capture unit 110.

Road surface estimation device 100 estimates the road surface shape (profile), and includes spatial measurement unit 120, road surface model creator 130, filter 140, and road surface estimator 150.

Image capture unit 110 captures a front view of own vehicle. For example, image capture unit 110 is a stereo camera including a left camera and a right camera. Alternatively, image capture unit 110 is a camera capable of three-dimensional measurement, such as a TOP (Time Of Flight) camera.

Spatial measurement unit 120 receives, from image capture unit 110, a left image and a right image obtained by capturing the same object with two cameras, i.e., the left camera and right camera. Spatial measurement unit 120 then measures a three-dimensional position of the same object from these images.

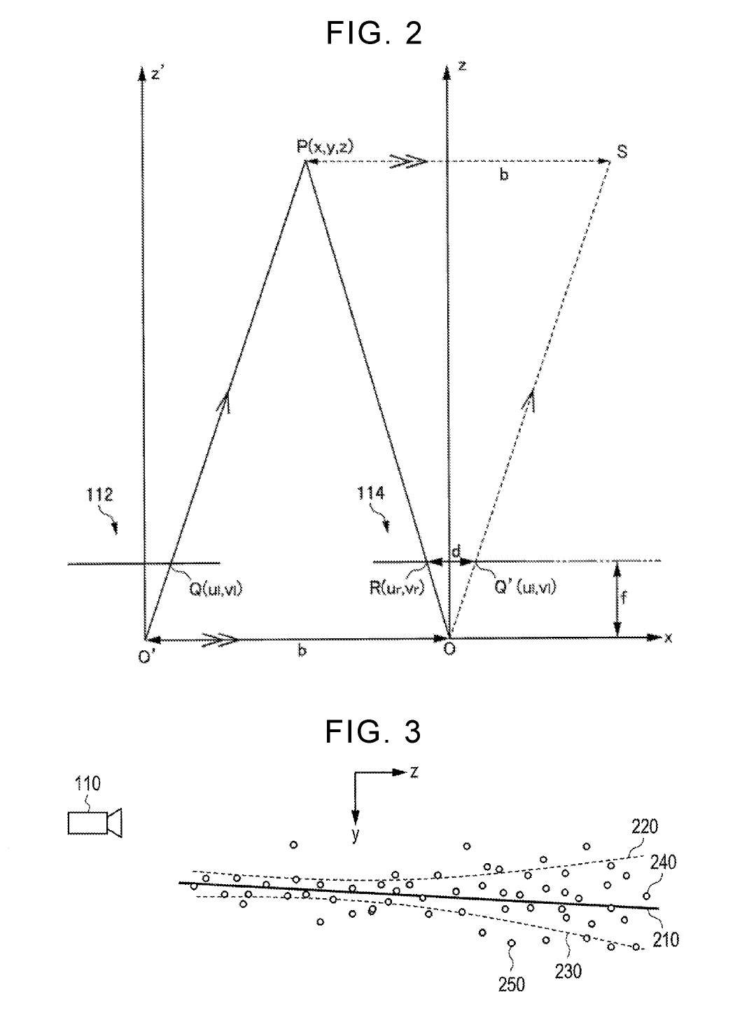

FIG. 2 illustrates coordinate conversion between the x-y-z coordinate system and the u-v-disparity coordinate system. In FIG. 2, position P of the object is captured at position Q in left image 112, and is captured at position R in right image 114. In FIG. 2, the y axis and the v axis extend in the depth direction of paper, and the u axis and the v axis extend in the horizontal direction and vertical direction, respectively, in left image 112 and right image 114.

u-v coordinate value (uₗ, vₗ) of position Q in left image 112 matches x-y coordinate value (uₗ, vₗ) of position Q centering on focal point O′ of the left camera. u-v coordinate value (uᵣ, vᵣ) of position R in right image 114 matches x-y coordinate value (uᵣ, vᵣ) of position R centering on focal point O of the right camera.

First, x-y-x coordinate value (x, y, z) of position P of the object centering on focal point O of the right camera is expressed using u-v-disparity coordinate value (uᵣ, vᵣ, d) of position P of the object, distance b between the cameras, and focal point distance f. Here, d defined as uₗ−uᵣ shows a disparity value.

Assuming that point Q′ is a cross point where line segment OS, which is same as line segment O′P moved in parallel to pass point O, crosses right image 114, point Q′ has x-y coordinate value (ul, vl) centering on point O. Formula (1) below is derived by focusing attention on triangle OPS.

x:b=uᵣ:d (1)

The same formula is established for the y coordinate (depth direction in FIG. 2) and the z coordinate. From these formulae, formula (2), which is a conversion equation from u-v-disparity coordinate value (uᵣ, vᵣ, d) to x-y-z coordinate value (x, y, z), is derived.

$$( x , y , z ) = ( \frac{{bu}_{r}}{d} , \frac{{bv}_{r}}{d} , \frac{bf}{d} ) \qquad ( 2 )$$

Next, u-v-disparity coordinate value (uᵣ, vᵣ, d) of position P of the object is expressed using x-y-z coordinate value (x, y, z) of position P of the object centering on focal point O of the right camera, distance b between the cameras, and focal point distance f. Next Formula (3) is derived on the basis of FIG. 2.

x:uᵣ=y:vᵣ=z:f (3)

From Formula (3), next Formula (4), which is a conversion equation from x-y-z coordinate value (x, y, z) to u-v-disparity coordinate value (uᵣ, vᵣ, d) is derived.

$$( {u}_{r} , {v}_{r} , d ) = ( \frac{fx}{z} , \frac{fy}{z} , \frac{fb}{z} ) \qquad ( 4 )$$

Accordingly, note that a three-dimensional measurement point of an object can be expressed by both the x-y-z coordinate system and u-v-disparity coordinate system.

Spatial measurement unit 120 detects the same object from the left image and the right image, and outputs three-dimensional measurement point cloud of the same object. For example, to detect the same object, disparity information is used, such as a disparity map in which disparity of a portion corresponding to each pixel of a left image or a right image is mapped. For example, SGM is used for obtaining the disparity map. When image capture unit 110 is a camera capable of three-dimensional measurement, spatial measurement unit 120 may output results of three-dimensional measurement by image capture unit 110 as they are as three-dimensional measurement point cloud. As described above, spatial measurement unit 120 measures the three-dimensional measurement point cloud on the road surface of a street based on the image input from image capture unit 110 mounted to a vehicle that is traveling along the street where the road surface is in front of the vehicle.

The three-dimensional measurement point cloud output from spatial measurement unit 120 contains errors typically due to error in disparity information. FIG. 3 is a projection view of road surface model 210 and three-dimensional measurement point cloud on the y-z plane in the x-y-z coordinate system. Here, the y axis extends in the vertical direction, and the z axis extends in the forward direction of the vehicle. The three-dimensional measurement point cloud is distributed in a range, as shown in FIG. 3. When the road surface is estimated on the basis of three-dimensional measurement point cloud containing such errors, the estimated road surface will also include errors.

In the first exemplary embodiment, filter 140 therefore filters a three-dimensional measurement point cloud output from spatial measurement unit 120 before road surface estimator 150 estimates the road surface, and obtains road surface candidate points as a road surface candidate point cloud included in the three-dimensional measurement point cloud. Filter 140 applies filtering with reference to FIG. 3, which is described later, on the basis of information representing the road surface, which is different from information on the aforementioned three-dimensional measurement point cloud. This enables road surface estimator 150 to estimate the road surface on the basis of the road surface candidate points with higher accuracy. Accordingly, accuracy of estimated road surface also is improved. Still more, since the number of points in the three-dimensional measurement point cloud used for estimating the road surface is reduced, road surface estimator 150 can estimate the road surface faster.

Road surface model creator 130 creates road surface model 210 that is information indicating the road surface shape (profile). For example, road surface model creator 130 creates road surface model 210 representing planar or curved surface in a three-dimensional space as information indicating the road surface, based on three-dimensional map information and positional information of own vehicle. For example, road surface model creator 130 detects inclination of image capture unit 110 in a direction crossing the road, inclination along the road, and inclination in the shooting direction, in accordance with the three-dimensional map information and the positional information of the own vehicle, in order to align the coordinate system of the three-dimensional map and the coordinate system of image capture unit 110. Alternatively, road surface model creator 130 may detect inclination of image capture unit 110 in a direction crossing the road, inclination along the road, and inclination in the shooting direction, in accordance with inclination information input from a tilt sensor that detects inclination of the own vehicle.

Three-dimensional map information is, for example, information on longitudinal slope of road, information on transverse slope of road, and road width information. The three-dimensional map information preferably has accuracy higher than general map information used in car navigation systems. The road width information may include a right width that is a width of road from the center line to the right-hand side, and a left width that is a width of road from the center line to the left-hand side. Road surface model creator 130 creates road surface model 210 in the form of quadric surface with respect to the shooting direction of image capture unit 110 on the basis of the three-dimensional map information and the positional information of the own vehicle. For example, road surface creator 130 creates road surface model 210 within a range of road width. However, road surface model 210 may be created out of the range of road width by extending the transverse slope of road.

Filter 140 receives road surface model 210 created by road surface model creator 130. Then, filter 140 determines a filter to be used for determining whether to adopt a three-dimensional measurement point as a road surface candidate point or eliminate it as unsuitable candidate point on the basis of road surface model 210. For example, the filter is characterized by a range defined by a filter width that is a distance in the normal direction from road surface model 210. For example, as shown in FIG. 3, the filter is characterized by a range defined by upper filter width limit 220 and lower filter width limit 230.

For example, filter 140 changes the filter width according to an error characteristic of image capture unit 110. When image capture unit 110 is a stereo camera, the three-dimensional measurement point cloud measured by spatial measurement unit 120 contain errors proportional to the square of a distance from image capture unit 110 to each of the three-dimensional measurement points. In other words, farther the distance of an object from image capture unit 110, larger the error contained in the three-dimensional measurement point cloud. Accordingly, excessive elimination of faraway points can be suppressed by changing the filter width in accordance with a distance of the object from image capture unit 110. In the example, the filter width is broadened as the object is farther away from image capture unit 110, as shown in FIG. 3. However, a change of the filter width is not limited to a successive change according to the distance from image capture unit 110, as shown in FIG. 3. For example, the filter width may be set to 10 cm for a distance shorter than 10 m, and set to 30 cm for a distance longer than 10 m so that the filter width is changed stepwise in accordance with the distance of the object from image capture unit 110.

Upon receiving road surface model 210 from road surface model creator 130, filter 140 filters the three-dimensional measurement point cloud input from spatial measurement unit 120, so as to obtain road surface candidate points. In FIG. 3, three dimensional measurement points 240 inside the range defined by upper filter width limit 220 and lower filter width limit 230 are adopted as road surface candidate points, and three-dimensional points 250 outside the range are eliminated as unsuitable measurement points.

Road surface estimator 150 estimates the road surface on the basis of the road surface candidate points output from filter 140. As described above, the three-dimensional measurement point cloud contains larger error as the object is away from image capture unit 110. Here, a z-coordinate value becomes larger and a disparity coordinate value (disparity value) becomes smaller as the object is farther from image capture unit 110. Conversely, a z-coordinate value becomes smaller and the disparity coordinate value (disparity value) becomes larger as the object is closer to image capture unit 110. Accordingly, for example, road surface estimator 150 estimates the road surface from larger disparity coordinate values that contain less error in the three-dimensional measurement point cloud to smaller disparity coordinate values.

For example, the space is divided into multiple areas in the direction of disparity coordinate axis. Parameters are calculated, starting from an area corresponding to larger disparity values and then to an adjacent area in turn, using next Formula (5).

vᵣ=a₀+aₗuᵣ+a₂d+a₃uᵣ²+a₄d² (5)

By using a quadratic surface expressed by above Formula (5), parameter a₀-a₄ that minimizes the errors in the road surface candidate points in the applicable area can be obtained by using, for example, the least-square method.

After obtaining parameters a₀-a₄ for all areas, road surface estimator 150 estimates the road surface by connecting quadratic surfaces specified by these parameters. The estimated road surface is an aggregate of the road surface candidate points. In other words, the estimated road surface is an area within which the vehicle is allowed to travel. Road surface estimator 150 outputs the information (the profile) of the estimated road surface, which is the information of the connected quadratic surfaces, to vehicle controller 160.

In an estimated road surface that is a road surface estimated by road surface estimator 150, a road surface that is not expressed in the three-dimensional map information used for estimation is also estimated. Accordingly, an estimated road surface closer to the actual road surface can be obtained, compared to a road surface estimated only on the basis of the map information.

Vehicle controller 160 controls the vehicle on the basis of the estimated road surface. Specifically, vehicle controller 160 controls at least a traveling direction and a speed of the vehicle. For example, vehicle controller 160 controls the own vehicle to avoid an obstacle in accordance with an input from a recognition unit (not illustrated) that recognizes the obstacle in front of the vehicle on the basis of the estimated road surface and the three-dimensional measurement point cloud output from spatial measurement unit 120. Still more, there are cases that the estimated road surface is rough due to, for example, unpaved road, a road under construction, or a distance in level or a dent in the road. In these cases, vehicle controller 160 controls the own vehicle to, for example, reduce a vehicle speed or reduce rigidity of suspension to absorb impact, in accordance with the profile of the estimated road surface. By controlling the own vehicle on the basis of the estimated road surface, vehicle controller 160 can control the own vehicle in line with a condition of road surface that the own vehicle will pass soon. Accordingly, the vehicle can be controlled more flexibly, compared to the case of controlling the vehicle in accordance with the actual vibration. The comfort of the own vehicle can thus be improved. Furthermore, aforementioned recognition unit can identify a three-dimensional object other that the road surface by subtracting points equivalent to the road surface (e.g., the road surface candidate point cloud output from filter 140) from the three-dimensional measurement points output from spatial measurement unit 120. By identifying a three-dimensional object other than the road surface, road surface estimation device 100 can be applied to the purpose of searching a driving route or recognizing obstacles.

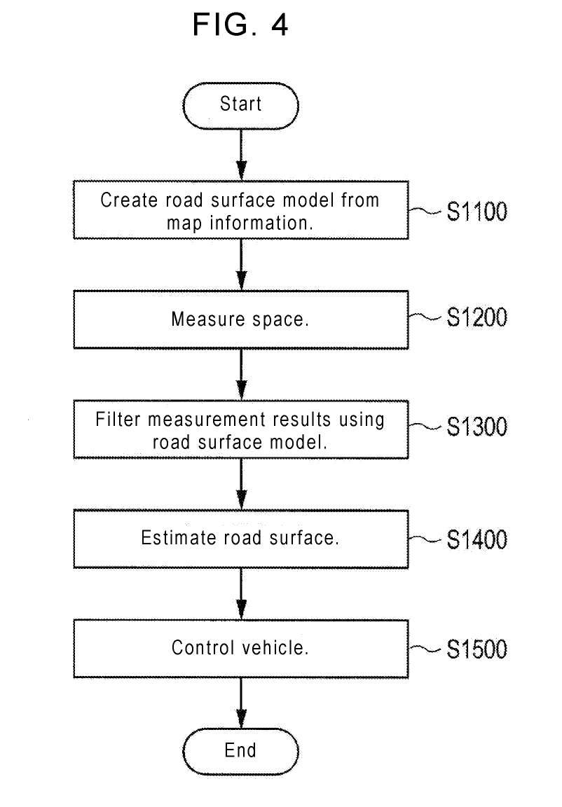

FIG. 4 is an operation flow chart of road surface estimation device 100. First, road surface model creator 130 creates road surface model 210 from map information (Step S1100). Then, spatial measurement unit 120 measures a space in front of the vehicle on the basis of images captured by image capture unit 110 (Step S1200). Here, the sequence of Step S1100 and Step S1200 may be reversed. Then, filter 140 filters three-dimensional measurement point cloud output from spatial measurement unit 120, by using road surface model 210 created by road surface model creator 130, so as to obtain road surface candidate points (Step S1300). Then, road surface estimator 150 estimates the road surface, using the road surface candidate points (Step S1400). Then, vehicle controller 160 controls the own vehicle in accordance with the road surface estimated by road surface estimator 150 (Step S1500).

For example, road surface model creator 130 creates road surface model 210 for each frame of image captured by image capture unit 110, spatial measurement unit 120 measures a space in front of the vehicle, filter 140 filters three-dimensional measurement point cloud, and then road surface estimator 150 estimates the road surface. This enables to increase accuracy of estimation of three-dimensional measurement point cloud far from image capture unit 110, where estimation accuracy of these three-dimensional measurement point cloud is lower than that of points closer to image capture unit 110, as the vehicle drives closer to these faraway points.

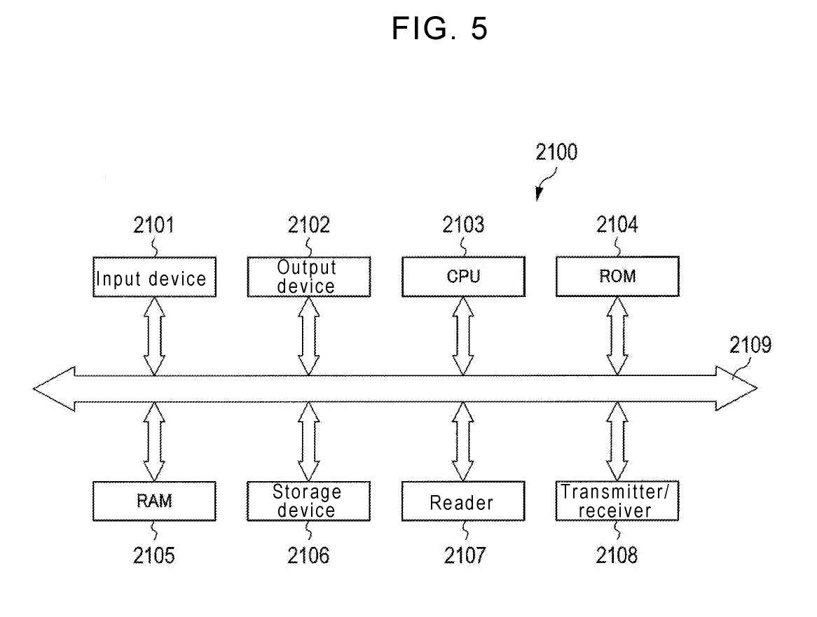

FIG. 5 is an example of hardware configuration of computer 2100 configuring road surface estimation device 100 and vehicle control device 200 shown in FIG. 1. Computer 2100 executes a program to achieve the function of each part in aforementioned exemplary embodiments and modified examples.

As shown in FIG. 5, computer 2100 includes input unit 2101, output unit 2102, CPU (Central Processing Unit) 2103 as a processor, ROM (Read Only Memory) 2104, RAM (Random Access Memory) 2105, storage device 2106, reader 2107, and transmitter/receiver 2108. Input unit 2101 is, for example, one or more input buttons, and/or a touch pad. Output unit 2102 is, for example, a display and/or loudspeaker. Storage device 2106 is, for example, a hard disk device and/or SSD (Solid State Drive). Reader 2107 reads information from a recording medium, such as a DVD-ROM (Digital Versatile Disk Read Only Memory) and USB (Universal Serial Bus) memory. Transmitter/receiver 2108 establishes communication via network. Aforementioned parts are connected via bus 2109.

Reader 2107 reads a program for executing functions of the aforementioned parts from the recording medium where the program is recorded, and store the program in storage device 2106. Alternatively, transmitter/receiver 2108 establishes communication with a server device connected to a network, and downloads a program for executing functions of the aforementioned parts from the server device and allows the program to be stored in storage device 2106.

Then, CPU 2103 copies the program stored in storage device 2106 to RAM 2105, reads out commands in the program sequentially from RAM 2105, and executes the commands to achieve the functions of the aforementioned parts. On executing the program, information obtained through a range of processes described in the exemplary embodiments is stored in RAM 2105 or storage device 2106, and used as required. Note that the three-dimensional map information may be stored either in ROM 2104, RAM 2105 or storage device 2106, and the three-dimensional map information may be stored in advance or at the time when it is needed.

### Second Exemplary Embodiment

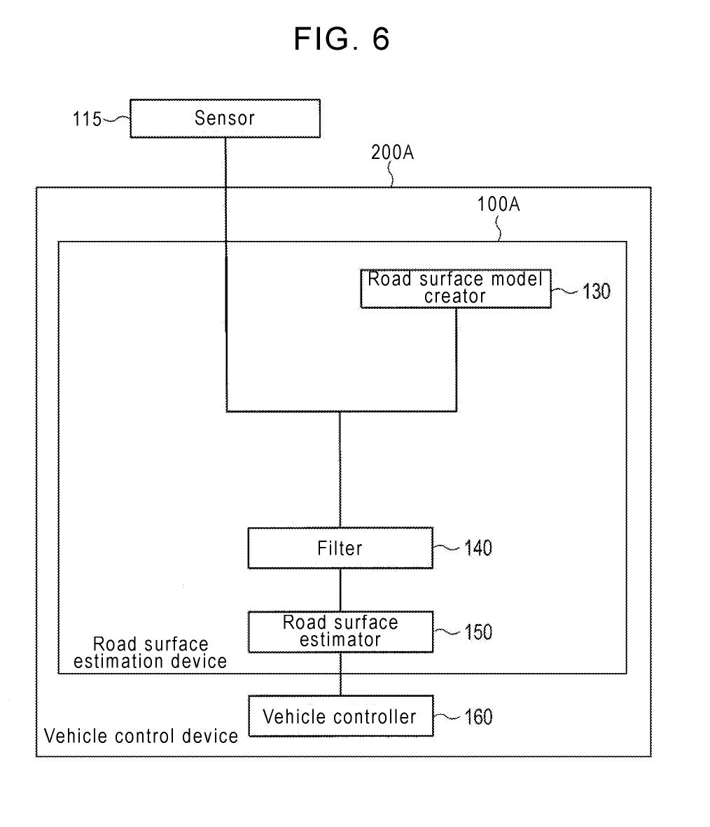

FIG. 6 is a block diagram of vehicle control device 200A in a second exemplary embodiment.

Vehicle control device 200 according to the first exemplary embodiment is connected to external image capture unit 110 which is composed with a stereo camera or a camera capable of three-dimensional measurement. On the other hand, vehicle control device 200A is connected to sensor 115 capable of three-dimensional measurement. Vehicle control device 200A includes road surface estimation device 100A and vehicle controller 160. Alternatively, road surface estimation device 100A or vehicle controller 160 may include sensor 115.

Examples of sensor 115 includes a Laser Imaging Detection and Ranging (LiDAR), a millimeter-wave radar, and a sonar. Sensor 115 output a plurality of three-dimensional measurement point cloud to filter 140 of road surface estimation device 100A.

Road surface estimation device 100A acquires the three-dimensional measurement point cloud on a road surface of a street from sensor 115 where sensor is mounted to a vehicle that is traveling along the street, and the road surface is in front of the vehicle. Therefore, road surface estimation device 100A does not include spatial measurement unit 120. Accordingly, Step S1200 in FIG. 4 is unnecessary any more. The other parts are the same as those in the first exemplary embodiment. The devices described above can achieve the same effects as those in the first exemplary embodiment.

The road surface estimation device of the present disclosure is preferably applicable to estimation of a road surface from images captured typically by a stereo camera.

What is claimed is:

1. A road surface estimation device comprising:
at least one memory storing three-dimensional map information and instructions; and
a processor that, when executing the instructions stored in the at least one memory, performs operations comprising:
measuring a plurality of three-dimensional measurement points as a three-dimensional measurement point cloud on a road surface of a street based on an image input from one of a stereo camera and a camera capable of three-dimensional measurement, which is to be mounted to a vehicle that is to be traveling along the street, the road surface being in front of the vehicle;
creating a road surface model based on the three-dimensional map information stored in the at least one memory;
filtering the three-dimensional measurement point cloud based on the road surface model so as to obtain road surface candidate points; and
outputting an aggregate of the road surface candidate points as an area within which the vehicle is allowed to travel to a controller of the vehicle, the controller being configured to control at least a traveling direction and a speed of the vehicle.

2. The road surface estimation device according to claim 1,
wherein, when filtering the three-dimensional measurement point cloud, the processor adopts a first part of the three-dimensional measurement point cloud within a range defined by a filter width as the road surface candidate points and eliminates a second part of the three-dimensional measurement point cloud out of the range as unsuitable candidate point cloud, the filter width being determined as a distance in a normal direction from one of a plane and a curved surface that are represented by the road surface model.

3. The road surface estimation device according to claim 2,
wherein the processor changes the filter width in accordance with a distance from the one of the stereo camera and the camera capable of three-dimensional measurement to each of the three-dimensional measurement points.

4. A vehicle control device comprising:
at least one memory storing three-dimensional map information and instructions; and
a processor that, when executing the instructions stored in the at least one memory, performs operations comprising:
measuring a plurality of three-dimensional measurement points as a three-dimensional measurement point cloud on a road surface of a street based on an image input from one of a stereo camera and a camera capable of three-dimensional measurement, which is to be mounted to a vehicle that is to be traveling along the street, the road surface being in front of the vehicle;
creating a road surface model based on the three-dimensional map information stored in the at least one memory;
filtering the three-dimensional measurement point cloud based on the road surface model so as to obtain road surface candidate points; and
estimating an aggregate of the road surface candidate points as an area within which the vehicle is allowed to travel;
controlling at least a traveling direction and a speed of the vehicle in accordance with the area within which the vehicle is allowed to travel.

5. The vehicle control device according to claim 4,
wherein, when filtering the three-dimensional measurement point cloud, the processor adopts a first part of the three-dimensional measurement point cloud within a range defined by a filter width as the road surface candidate points and eliminates a second part of the three-dimensional measurement point cloud out of the range as unsuitable candidate point cloud, the filter width being determined as a distance in a normal direction from one of a plane and a curved surface that are represented by the road surface model.

6. The vehicle control device according to claim 5,
wherein the processor changes the filter width in accordance with a distance from the one of the stereo camera and the camera capable of three-dimensional measurement to each of the three-dimensional measurement point point.

7. The vehicle control device according to claim 4,
wherein the processor estimates a shape of the road surface in the area within which the vehicle is allowed to travel from the road surface candidate points, and
the processor adjusts a rigidity of a suspension of the vehicle in accordance with the shape of the road surface.

8. The vehicle control device according to claim 4,
wherein the processor estimates a shape of the road surface in the area within which the vehicle is allowed to travel from the road surface candidate points, and
the processor adjusts the speed of the vehicle in accordance with the shape of the road surface.

9. A road surface estimation method comprising:
measuring a plurality of three-dimensional measurement points as a three-dimensional measurement point cloud on a road surface of a street based on an image input from one of a stereo camera and a camera capable of three-dimensional measurement, which is mounted to a vehicle that is traveling along the street, the road surface being in front of the vehicle;
creating a road surface model based on the three-dimensional map information preliminarily stored;
filtering the three-dimensional measurement point cloud based on the road surface model so as to obtain road surface candidate points; and
outputting an aggregate of the road surface candidate points as an area within which the vehicle is allowed to travel to a controller of the vehicle, the controller being configured control at least a traveling direction and a speed of the vehicle.

10. A road surface estimation device comprising:
at least one memory storing three-dimensional map information and instructions; and
a processor that, when executing the instructions stored in the at least one memory, performs operations comprising:
acquiring a plurality of three-dimensional measurement points as a three-dimensional measurement point cloud on a road surface of a street from a sensor capable of three-dimensional measurement, the sensor being to be mounted to a vehicle that is to be traveling along the street, and the road surface being in front of the vehicle;
creating a road surface model based on the three-dimensional map information stored in the at least one memory;
filtering the three-dimensional measurement point cloud based on the road surface model so as to obtain road surface candidate points; and
outputting an aggregate of the road surface candidate points as an area within which the vehicle is allowed to travel to a controller of the vehicle, the controller being configured to control at least a traveling direction and a speed of the vehicle.

11. The road surface estimation device according to claim 10,
wherein, when filtering the three-dimensional measurement point cloud, the processor adopts a first part of the three-dimensional measurement point cloud within a range defined by a filter width as the road surface candidate points and eliminates a second part of the three-dimensional measurement point cloud out of the range as unsuitable candidate point cloud, the filter width being determined as a distance in a normal direction from one of a plane and a curved surface that are represented by the road surface model.

12. The road surface estimation device according to claim 11,
wherein the processor changes the filter width in accordance with a distance from the sensor to each of the three-dimensional measurement points.
